(19) United States
(12) Patent Application Publication
(10) Pub. No.: US 2014/0285760 A1
(43) Pub. Date: Sep. 25, 2014

(54) LIQUID CRYSTAL DISPLAY AND METHOD OF MANUFACTURING THE SAME

(71) Applicant: SAMSUNG DISPLAY CO., LTD., YONGIN-CITY (KR)

(72) Inventors: Dae Ho SONG, Hwaseong-si (KR); Min-Woo LEE, Seoul (KR); Jae Cheol PARK, Hwaseong-si (KR); Yeun Tae KIM, Suwon-si (KR); Woo Jae LEE, Yongin-si (KR)

(73) Assignee: SAMSUNG DISPLAY CO., LTD., YONGIN-CITY (KR)

(21) Appl. No.: 14/013,260

(22) Filed: Aug. 29, 2013

(30) Foreign Application Priority Data
Mar. 20, 2013 (KR) 10-2013-0029946

(51) Int. Cl. G02F 1/1337; G02F 1/1343

(52) U.S. Cl. CPC G02F 1/133711; G02F 1/133719; G02F 1/133788; G02F 1/13439
USPC 349/124; 349/123; 445/24

(57) ABSTRACT

The liquid crystal display including a substrate; a thin film transistor disposed on the substrate; a field generating electrode in electrical communication with the thin film transistor; and an alignment layer disposed on the field generating electrode, wherein the alignment layer includes a self-assembled monolayer (“SAM”) derived from at least a first precursor compound and a second precursor compound, and wherein the first and second precursor compounds are different.

This application claims priority to and the benefit of Korean Patent Application No. 10-2013-0029946, filed on Mar. 20, 2013, and all the benefits accruing therefrom under 35 U.S.C. §119, the content of which is incorporated herein in its entirety by reference.

### BACKGROUND

(a) Technical Field

The present disclosure relates to a liquid crystal display and a method of manufacturing the same.

(b) Description of the Related Art

A liquid crystal display, which is one of the most common types of flat panel displays currently in use, usually includes two sheets of panels having field generating electrodes, such as a pixel electrode or a common electrode, and a liquid crystal layer interposed therebetween.

By applying voltage to the field generating electrodes, the liquid crystal display generates an electric field in the liquid crystal layer, which causes the alignment of liquid crystal molecules of the liquid crystal layer, thus controlling polarization of incident light so as to display images.

A nano crystal display (“NCD”) is a device in which a display is manufactured by forming a sacrificial layer including an organic material, forming a roof layer on the sacrificial layer, removing the sacrificial layer, and then filling in a resulting microcavity formed by removing the sacrificial layer with a liquid crystal.

In particular, a method of manufacturing the nano crystal display (“NCD”) includes injecting and drying after injecting an alignment agent before injecting a liquid crystal, in order to arrange and align liquid crystal molecules. During the drying of the alignment agent, an aggregation of a solid alignment agent often occurs, which may lead to certain problems such as light leakage or deterioration of transmittance. Thus, there remains a need for a liquid crystal display including an alignment layer component which prevents an aggregation of the solid alignment agent.

### SUMMARY

Provided is a liquid crystal display including a new alignment layer component which prevents the aggregation of a solid alignment agent, and a method of manufacturing the same.

An exemplary embodiment provides a liquid crystal display, including:

a substrate;

a thin film transistor disposed on the substrate;

a field generating electrode in electrical communication with the thin film transistor; and

an alignment layer disposed on the field generating electrode,

wherein the alignment layer includes a self-assembled monolayer derived from at least a first precursor compound and a second precursor compound, and

wherein the first and second precursor compounds are different.

The self-assembled monolayer may be derived from a combination of the first precursor compound and the second precursor compound, and wherein the first precursor compounds is represented by Chemical formula A and the second precursor compound is represented by Chemical Formula B:

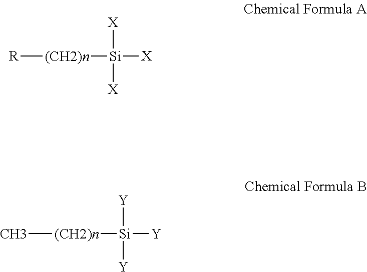

wherein in Chemical Formulas A and B,

R may be a functional group including a double bond,

n may be 1 to 30, and

X and Y may each independently be —Cl, —OCH₃, or —OC₂H₅.

The first precursor compound may be at least one of compounds represented by Chemical Formulas 1 to 8:

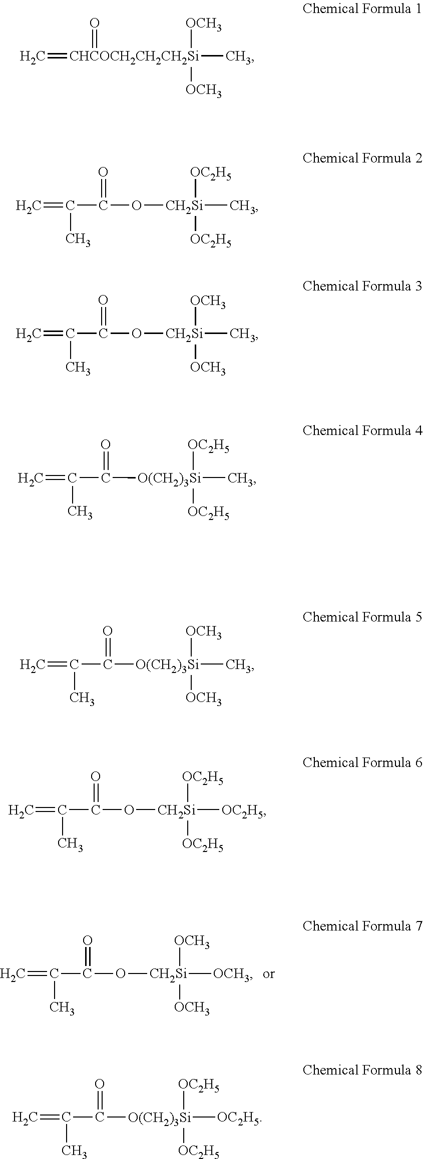

The second precursor compound may be at least one of octadecyltrichlorosilane (OTS) and octadecyltrimethoxysilane (OTMS).

The liquid crystal display may further include a liquid crystal layer disposed on the field generating electrode,

wherein the liquid crystal layer may include a liquid crystal and an alignment polymer, and

wherein the alignment polymer may be a product of light-irradiation of the liquid crystal and an alignment assistant agent.

A portion of the self-assembled monolayer derived from the first precursor compound may be a pretilt component, and a portion of the self-assembled monolayer derived from the second precursor compound may be a vertical alignment component.

The alignment assistant agent may include at least one of compounds represented by Chemical Formulas 9 to 13:

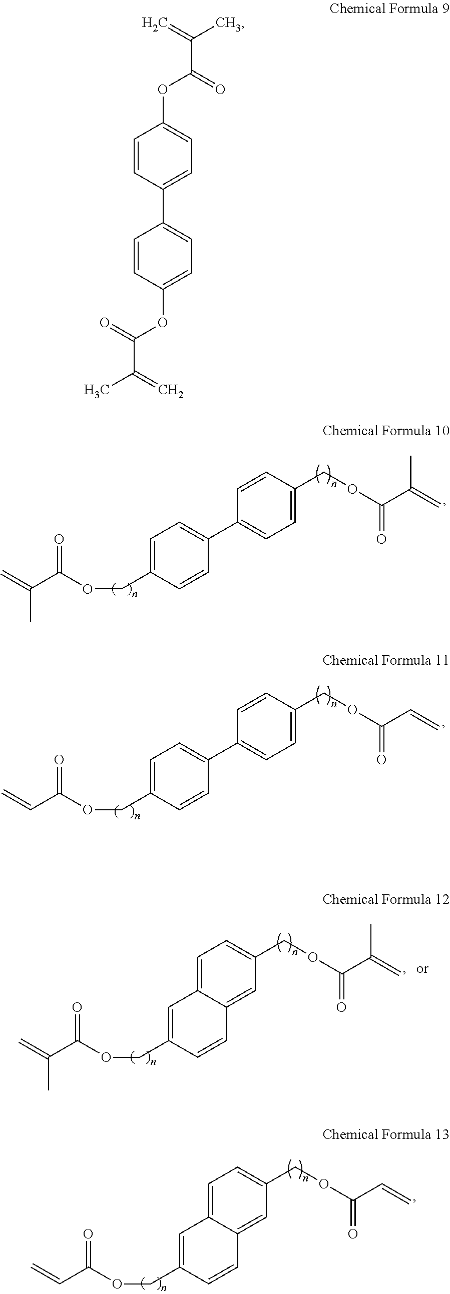

wherein in Chemical Formulas 9-13, n may be 0 to 5.

The field generating electrode may include a plurality of slit electrodes.

The self-assembled monolayer may further include a product of a third precursor compound represented by Chemical Formula C:

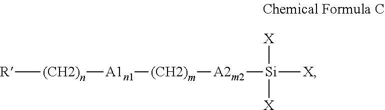

wherein in Chemical Formula C,

R′ may be a functional group including a methyl group or a double bond,

n, n1, m, and m2 may each independently be 1 to 30,

A1 and A2 may each independently be a C3 to C30 alicyclic group or a C3 to C30 aryl group, and

each X may be independently —Cl, —OCH₃, or —OC₂H₅.

The field generating electrode may have a surface treated by ultraviolet rays, ozone, or treatment with an aqueous combination of ammonium hydroxide and hydrogen peroxide.

The field generating electrode may further include a first insulating layer including silicon nitride (SiNx) or silicon oxide (SiO2).

The field generating electrode may include

a plurality of slit electrodes, and

may further include a second insulating layer including silicon nitride (SiNx) or silicon oxide (SiO2)

wherein the second insulating layer is disposed on the plurality of slit electrodes.

The liquid crystal display may further include

a liquid crystal layer including a liquid crystal disposed on the field generating electrode,

wherein the liquid crystal may be disposed vertically when an electric field is not present.

The liquid crystal display may further include

a roof layer facing the field generating electrode, and

a microcavity having a liquid crystal injection hole,

wherein the microcavity may be disposed between the field generating electrode and the roof layer, and

wherein the microcavity may further includes a liquid crystal layer including the liquid crystal.

The liquid crystal display may further include a common electrode disposed between the microcavity and the roof layer.

The self-assembled monolayer may be a condensation product of contacting a substrate with the product of the first precursor compound and the second precursor compound.

The product of the first precursor compound and the product of the second precursor compound may each be a hydrolysis product.

Another exemplary embodiment provides a method of manufacturing a liquid crystal display, the method including:

forming a field generating electrode on a first substrate;

forming an alignment layer on the field generating electrode;

forming a liquid crystal layer including a liquid crystal and an alignment assistant agent on the field generating electrode;

forming an electric field in the liquid crystal layer; and

light-irradiating the liquid crystal and the alignment agent to form an alignment polymer and manufacture the liquid crystal display,

wherein the alignment layer includes a self-assembled monolayer derived from a first precursor compound and second precursor compound, and

wherein the first and second precursor compounds are different.

The self-assembled monolayer may be derived from a combination of the first precursor compound represented by Chemical Formula A and the second precursor compound represented by Chemical Formula B:

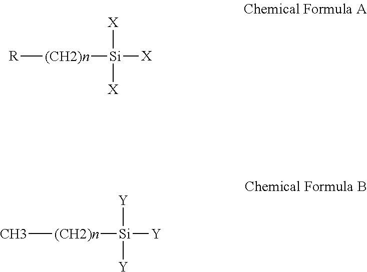

wherein in Chemical Formulas A and B,

R may be a functional group including a double bond,

n may be 1 to 30, and

X and Y may each independently be —Cl, —OCH₃, or —OC₂H₅.

The first precursor compound may be at least one of compounds represented by Chemical Formulas 1 to 8:

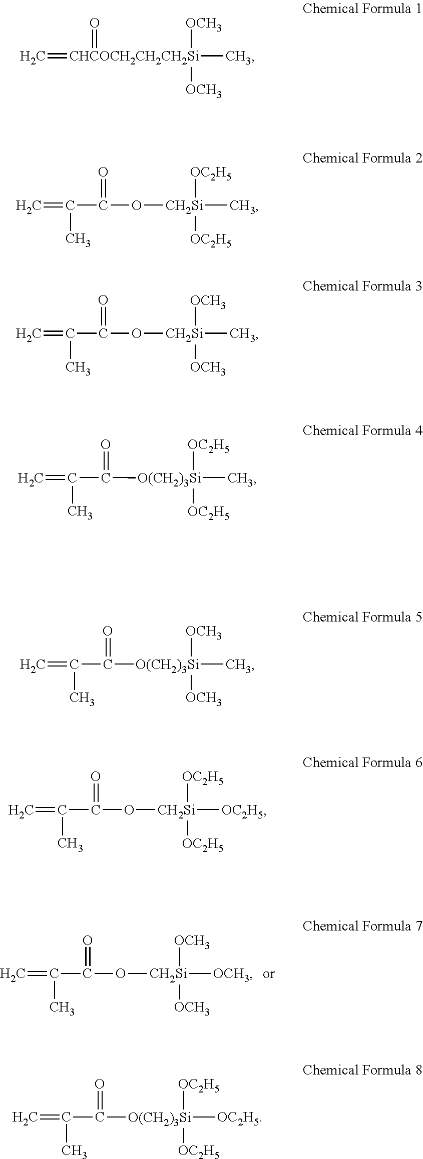

The second precursor compound may be at least one of octadecyltrichlorosilane (OTS) and octadecyltrimethoxysilane (OTMS).

A portion of the self-assembled monolayer derived from the first precursor compound may be a pretilt component of the liquid crystal, and a portion of the self-assembled monolayer derived from the second precursor compound may be a vertical alignment component of the liquid crystal.

The method of manufacturing a liquid crystal display may further include contacting the alignment layer with a solvent before forming an electric field in the liquid crystal layer.

The self-assembled monolayer may further include a product of a third precursor compound represented by Chemical Formula C:

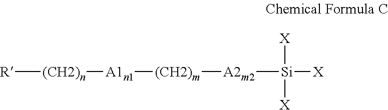

wherein in Chemical Formula C,

R′ may be a functional group including a methyl group or a double bond,

n, n1, m, and m2 may each independently be 1 to 30,

A1 and A2 may each independently be a C3 to C30 alicyclic group or a C3 to C30 aryl group, and

each X may independently be —Cl, —OCH₃, or —OC₂H₅.

The A1 and A2 of the present exemplary embodiment may each independently be

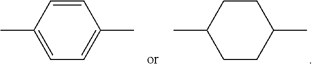

The method of manufacturing a liquid crystal display may further include treating the field generating electrode with ultraviolet rays, ozone, or an aqueous combination of ammonium hydroxide and hydrogen peroxide.

The method of manufacturing a liquid crystal display may further include forming a first insulating layer including silicon nitride or silicon oxide on the substrate before forming the field generating electrode.

The field generating electrode may include a plurality of slit electrodes, and the method of manufacturing a liquid crystal display may further include forming a second insulating layer made of silicon nitride or silicon oxide disposed on the plurality of slit electrodes.

The liquid crystal may be disposed vertically when an electric field is not present.

The method of manufacturing a liquid crystal display may further include

forming a sacrificial layer on the field generating electrode;

forming a roof layer on the sacrificial layer;

removing the sacrificial layer to form a microcavity including a liquid crystal injection hole; and

injecting the alignment material and the liquid crystal into the microcavity to form an alignment layer and a liquid crystal layer.

The method of manufacturing a liquid crystal display may further include forming a common electrode between the microcavity and the roof layer.

According to the exemplary embodiments, a liquid crystal may be vertically aligned by forming an alignment layer with self-assembled monolayers instead of an alignment agent including a known solid and an alignment layer is formed by mixing and using different kinds of self-assembled monolayers, and as a result, the liquid crystal may be set to be vertically aligned and initially aligned.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view illustrating an embodiment of a liquid crystal display;

FIG. 2 is a diagram schematically describing a mechanism of formation of an alignment layer in a region P of FIG. 1;

FIG. 3 is a diagram illustrating an embodiment of an alignment layer included in the liquid crystal display;

FIG. 4 is a cross-sectional view illustrating another embodiment of a liquid crystal display;

FIG. 5 is a plan view illustrating an embodiment of a liquid crystal display;

FIG. 6 is a cross-sectional view of the liquid crystal display of FIG. 5 taken along line VI-VI;

FIG. 7 is a cross-sectional view of the liquid crystal display of FIG. 5 taken along line VII-VII;

FIG. 8 is a perspective view illustrating an embodiment of a microcavity;

FIGS. 9 and 10 are cross-sectional views of the liquid crystal display of FIG. 5 taken along lines VI-VI and VII-VII and illustrate the liquid crystal display modifying the exemplary embodiments described in FIGS. 6 and 7, respectively;

FIGS. 11A and 11B are schematic diagrams illustrating an embodiment of a method of forming a pretilt of a liquid crystal by an alignment assistant agent; and

FIG. 12 is a diagram illustrating a position relationship of an alignment layer and an alignment assistant agent in a region Q of FIG. 11B.

### DETAILED DESCRIPTION OF THE EMBODIMENTS

Hereinafter, exemplary embodiments will be described in detail with reference to the accompanying drawings. As those skilled in the art would realize, the described embodiments may be modified in various different ways, all without departing from the spirit or scope of the present disclosure. The exemplary embodiments disclosed herein are provided to make this disclosure thorough and complete. Accordingly, the embodiments are described below, by referring to the figures, to explain aspects of the present description. As used herein, the term “and/or” includes any and all combinations of one or more of the associated listed items. The term “or” means “and/or.” Expressions such as “at least one of,” when preceding a list of elements, modify the entire list of elements and do not modify the individual elements of the list.

It will be understood that, although the terms first, second, third etc. may be used herein to describe various compounds, elements, components, regions, layers, and/or sections, and these elements, components, regions, layers, and/or sections should not be limited by these terms. These terms are only used to distinguish one compound, element, component, region, layer, or section from another element, component, region, layer, or section. Thus, a first compound element, component, region, layer, or section discussed below could be termed a second compound, element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Additional aspects will be set forth in part in the description which follows and, in part, will be apparent from the description.

In the drawings, the thickness of layers, films, panels, regions, etc., are exaggerated for clarity. It will be understood that when a layer is referred to as being “on” another layer or substrate, it can be directly on the other layer or substrate, or intervening them may also be present. In contrast, when an element is referred to as being “directly on” another element, there are no intervening elements present. Like reference numerals designate like elements throughout the specification.

“Alicyclic” means a cyclic hydrocarbon having properties of an aliphatic group. The alicyclic group may be a C5 to C30 cycloalkyl group, a C5 to C30 cycloalkenyl group, or a C5 to C30 cycloalkynyl group.

As used herein, the term “alkyl” indicates a monovalent or higher valency group derived from a completely saturated, branched or unbranched (or a straight or linear) hydrocarbon, and having the specified number of carbon atoms.

As used herein, the term “aryl” group, which is used alone or in combination, indicates a monovalent group derived from an aromatic hydrocarbon containing at least one ring, and having the specified number of carbon atoms, e.g., 3 to 30 carbon atoms. As used herein, the term “aryl” is construed as including a group with an aromatic ring fused to at least one cycloalkyl ring.

As used herein, the term “cycloalkyl” indicates a saturated hydrocarbon ring group, having only carbon ring atoms and having the specified number of carbon atoms.

As used herein, the term “cycloalkenyl” indicates a saturated hydrocarbon ring group, having only carbon ring atoms, including at least one double bond, and having the specified number of carbon atoms.

As used herein, the term “cycloalkynyl” indicates a saturated hydrocarbon ring group, having only carbon ring atoms, including at least one triple bond, and having the specified number of carbon atoms.

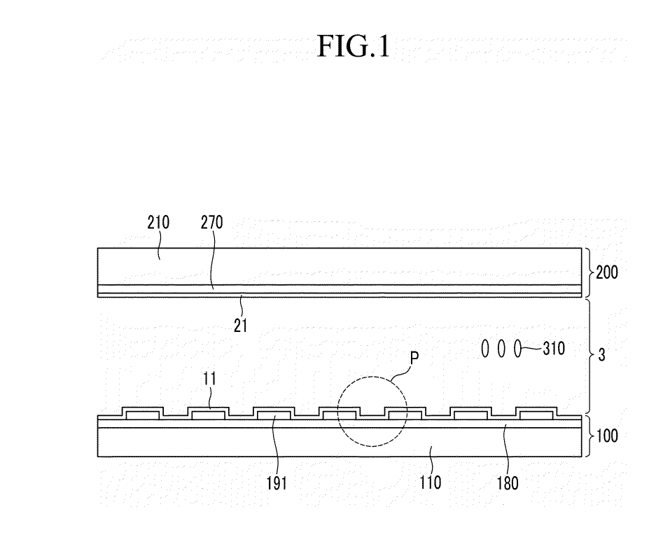

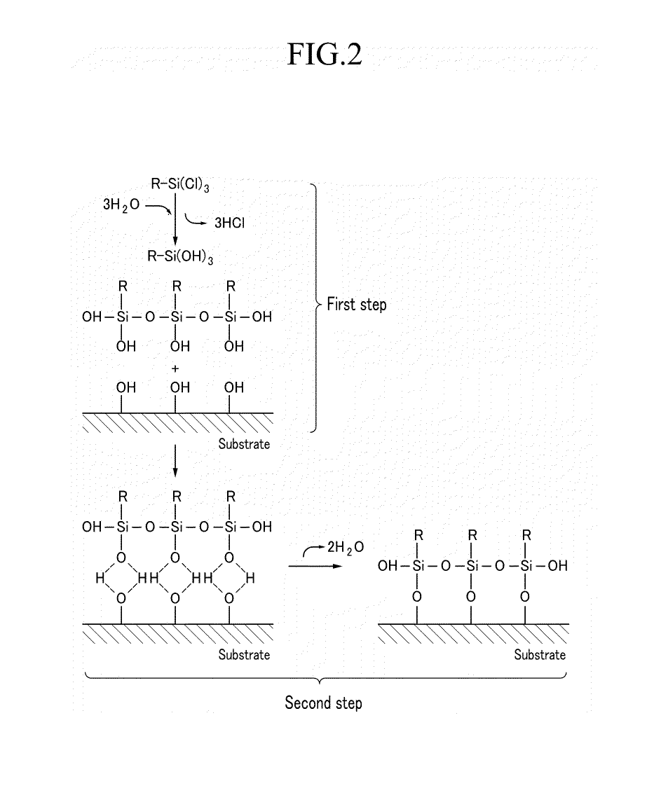

FIG. 1 is a cross-sectional view illustrating a liquid crystal display according to an exemplary embodiment. FIG. 2 is a diagram schematically describing a mechanism in which an alignment layer is formed in a region P of FIG. 1.

Referring to FIG. 1, a liquid crystal display according to an exemplary embodiment includes a lower panel 100 and an upper panel 200 facing each other, and a liquid crystal layer 3 interposed between the two panels 100 and 200.

In the lower panel 100, an insulating layer 180 including silicon oxide or silicon nitride is disposed on a substrate 110 comprising a transparent glass or plastic. A pixel electrode 191 including a slit electrode is disposed on the insulating layer 180. Although not illustrated, the pixel electrode 191 may have a surface treated by ultraviolet rays, ozone (O₃), or a Standard Cleaning 1 (“SC1”) method. The surface of the pixel electrode 191 may form an alignment layer including a self assembled monolayer to be described below including an OH-group introduced by the surface treatment.

The SC1 cleaning treatment means a cleaning method which was introduced by Werner Kern of the U.S., RCA Corporation.

A lower alignment layer 11 is positioned on the insulating layer 180 and the pixel electrode 191.

In the upper panel 200, a common electrode 270 is disposed on a transparent insulation substrate 210. An upper alignment layer 21 is disposed on the common electrode 270.

Polarizers (not illustrated) may be provided on outer surfaces of the lower panel 100 and the upper panel 200.

The alignment layers 11 and 21 according to the exemplary embodiment include a self-assembled monolayer (“SAMs”) derived from at least a first precursor compound and second precursor compound, wherein the first and second precursor compounds are different. For example, the self-assembled monolayer in the exemplary embodiment may be derived by mixing a first precursor compound represented by the following Chemical Formula A and a second precursor compound represented by the following Chemical Formula B, and contacting the mixture with a substrate.

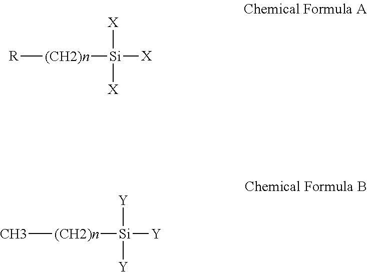

In Chemical Formulas A and B,

R is a functional group including a double bond,

n is 1 to 30, and X and Y are each independently —Cl, —OCH₃, or —OC₂H₅.

In an embodiment, R may comprise a vinyl group, an acrylate group, or a methacrylate group.

In the exemplary embodiment, the first precursor compound may be at least one of compounds represented by the following Chemical Formulas 1 to 8.

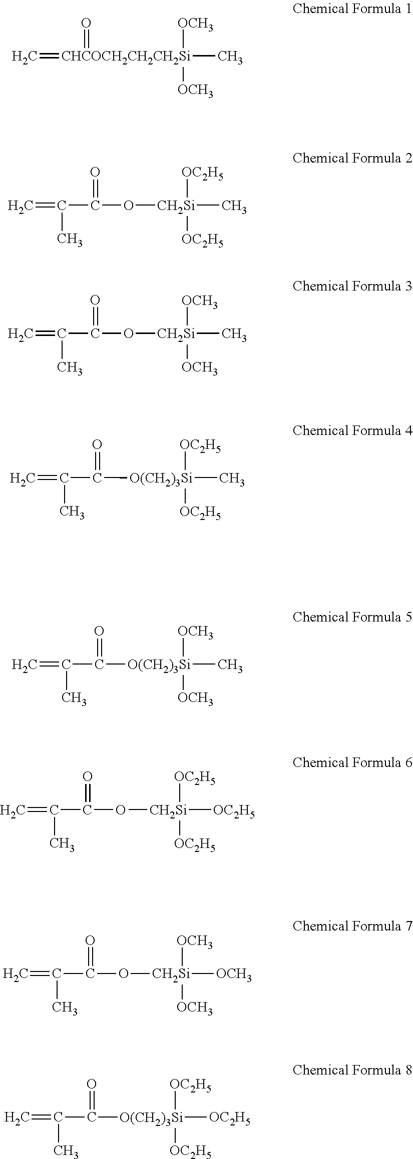

In the exemplary embodiment, the second precursor compound may be at least one of octadecyltrichlorosilane (“OTS”) and octadecyltrimethoxysilane (“OTMS”).

Hereinafter, referring to FIG. 2, and while not wanting to be bound by theory, a mechanism of formation of the alignment layers 11 and 21 including the self-assembled monolayer will be schematically described.

Referring to FIG. 2, when the second precursor compound is octadecyltrichlorosilane (“OTS”) in the region P of FIG. 1, a process of chemically reacting with the substrate surface with the —OH group is illustrated.

In a first step, which is a hydrolysis step, octadecyltrichlorosilane reacts with water to form a silanol intermediate having an —OH group. Here, R may be an alkyl group.

In a second step, a condensation reaction takes place, wherein the silanol intermediate reacts with the —OH group of the substrate surface to form an alignment layer including the self-assembled monolayer, and the alkyl group R may serve to vertically align a liquid crystal 310 (shown in FIG. 1).

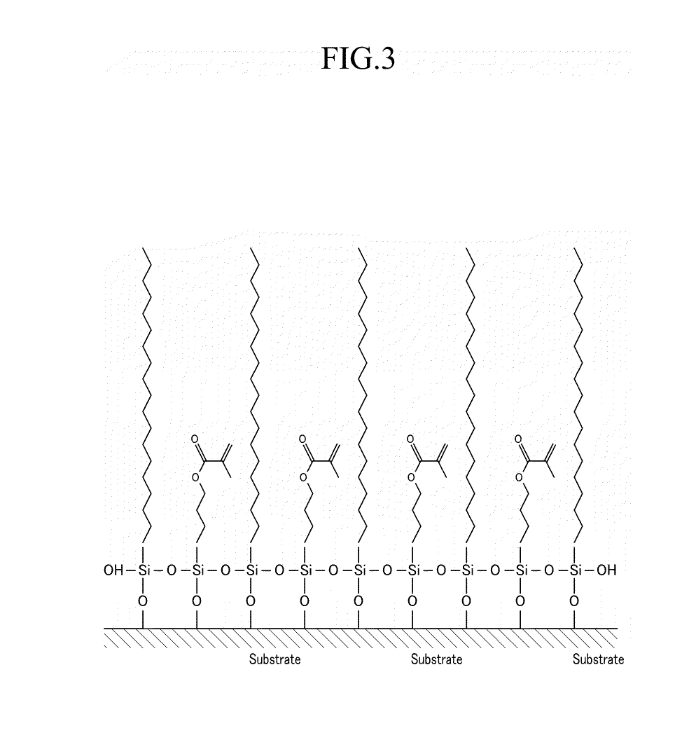

FIG. 3 is a diagram illustrating an alignment layer included in the liquid crystal display according to the exemplary embodiment.

Referring to FIG. 3, according to an exemplary embodiment, an alignment layer including the self-assembled monolayer, derived from the first and second precursor compounds, which are different, is illustrated. In the exemplary embodiment, the first precursor compound is methacryloxypropyltrimethoxysilane (“MPS”), and the second precursor compound is octadecyltrichlorosilane. As such, when the first step and the second step are carried out according to the mechanism shown in FIG. 2, the alignment layer including the self-assembled monolayer is formed as illustrated in FIG. 3.

Hereinafter, a method of forming the lower alignment layer 11 according to the exemplary embodiment will be schematically described with reference to FIG. 1.

An upper surface of the insulating layer 180 or the pixel electrode 191 may be treated by an ultraviolet rays, ozone (O₃), or SC1 method. As a result of the treatment, an OH group is attached to the upper surface of the pixel electrode 191.

Thereafter, the first precursor compound and the second precursor compound, which may be in a liquid state, may be diluted with a solvent, which may include ethanol, heptane, or hexane, or the like and the resulting mixture may be coated on the insulating layer 180 or the pixel electrode 191. In this case, a dipping process, spin coating, spray coating, or inkjet printing may be used.

Thereafter, and while not wanting to be bound by theory, the first precursor compound and the second precursor compound, which are understood to not react with each other, may be removed by solvent rinsing. A material used in the solvent rinsing may include ethanol, heptane, hexane, or the like.

Next, curing may be performed at a temperature of approximately 110° C. to about 180° C. for about 1 minute to about 60 minutes, specifically about 10 minutes.

The upper alignment layer 21 may be formed by mixing the first and second precursor compounds and coating the resulting mixture on the upper surface of the common electrode 270 after treating the upper surface with ultraviolet rays, ozone (O₃), or SC1 method, similarly to the method of forming the lower alignment layer 11 described above.

In order to prepare a polyimide type alignment layer in the related art, after coating a solid component and a solvent, one generally performs a baking process for a long time at a temperature of about 200° C. or greater. Since the solid becomes aggregated at a predetermined portion, there are some portions wherein the liquid crystals are not aligned. However, in the exemplary embodiment, the baking process may be performed at a relatively low temperature. In addition, a process time may be shortened by mixing the different kinds of liquid precursor materials. Furthermore, since the alignment layer is formed without the solid component, a phenomenon wherein the liquid crystal is not aligned due to the aggregation does not occur.

In the exemplary embodiment described above, the self-assembled monolayer may further comprise a product of a third precursor compound represented by the following Chemical Formula C:

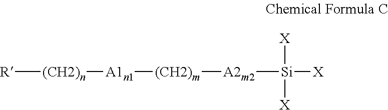

In Chemical Formula C,

R′ is a functional group including a methyl group or a double bond,

n, n1, m, and m2 are each independently 1 to 30

A1 and A2 are each independently a C3 to C30 alicyclic group or a C3 to C30 aryl group, and

each X is independently —Cl, —OCH₃, or —OC₂H₅. In an exemplary embodiment, A1 and A2 may each independently be

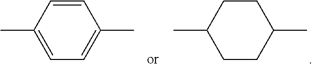

In the exemplary embodiment, when the self-assembled monolayer is further derived from the third precursor compound, the alkyl group included in the self-assembled monolayer may reinforce the alignment of the liquid crystal 310 due to the A1 or A2 group included in the third precursor compound.

In the exemplary embodiment, the liquid crystal layer 3 may include the liquid crystal 310 and an alignment polymer. The alignment polymer may be formed by light-irradiating the liquid crystal 310 and the alignment assistant agent. The alignment polymer reacts with the self-assembled monolayer derived from the first precursor compound described above to generate a pretilt component of the liquid crystal 310. On the contrary, the self-assembled monolayer derived from the second precursor compound serves to vertically align the liquid crystal 310 due to the alkyl group which is extended at an end.

In the exemplary embodiment, the alignment assistant agent may be at least one of compounds represented by the following Chemical Formulas 9 to 13.

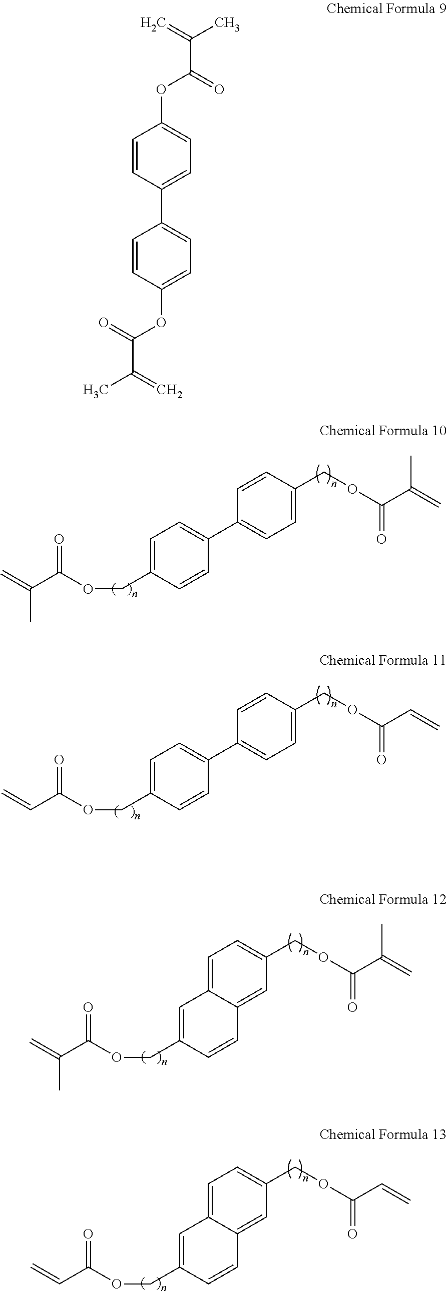

In Chemical Formulas 9-13, n is 0 to 5.

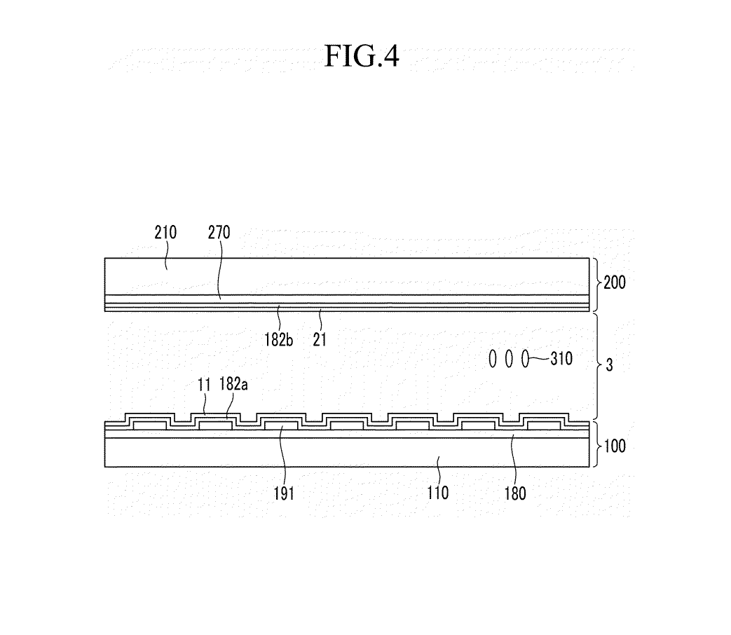

FIG. 4 is a cross-sectional view illustrating an embodiment of a liquid crystal display according to an exemplary embodiment.

Referring to FIG. 4, the exemplary embodiment has almost the same constituent elements as the exemplary embodiment described in FIG. 1 and so the description of FIG. 1 may also be applied to FIG. 4, with the exception that a first overcoat 182a covering the pixel electrode 191 and a second overcoat 182b covering the common electrode 270 are formed on the insulating layer 180. Also, the treatment of the upper surface of the common electrode 270 or the pixel electrode 191 with ultraviolet rays, ozone (O₃), or SC1 method discussed with regard to FIG. 1 may be omitted. Since the overcoats 182a and 182b may comprise silicon nitride (SiNx) or silicon oxide (SiO₂) and —OH groups are naturally formed on the surfaces of the overcoats 182a and 182b, an effect of the surface treatment with ultraviolet rays, ozone (O₃), or SC1 method may be achieved.

In the exemplary embodiment, the overcoats 182a and 182b are formed to cover the pixel electrode 191 and the common electrode 270, respectively, and an overcoat may be formed to cover only one of the pixel electrode 191 and the common electrode 270, and surface treatment with ultraviolet rays, ozone (O₃), or Standard Cleaning 1 may be added.

Hereinafter, the liquid crystal display including the alignment layer according to the exemplary embodiment described above will be described in more detail as an example.

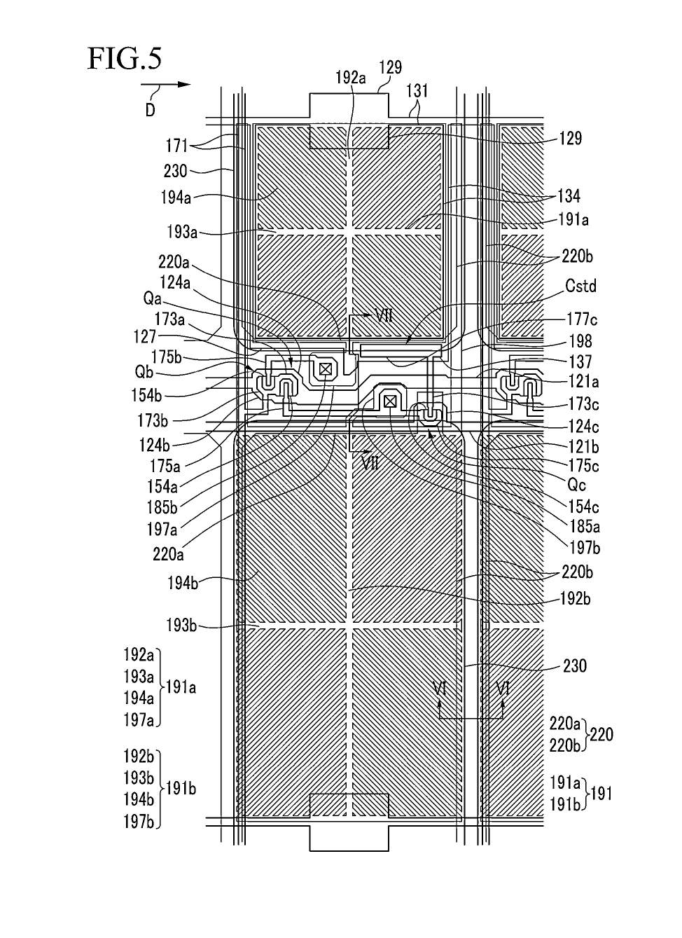

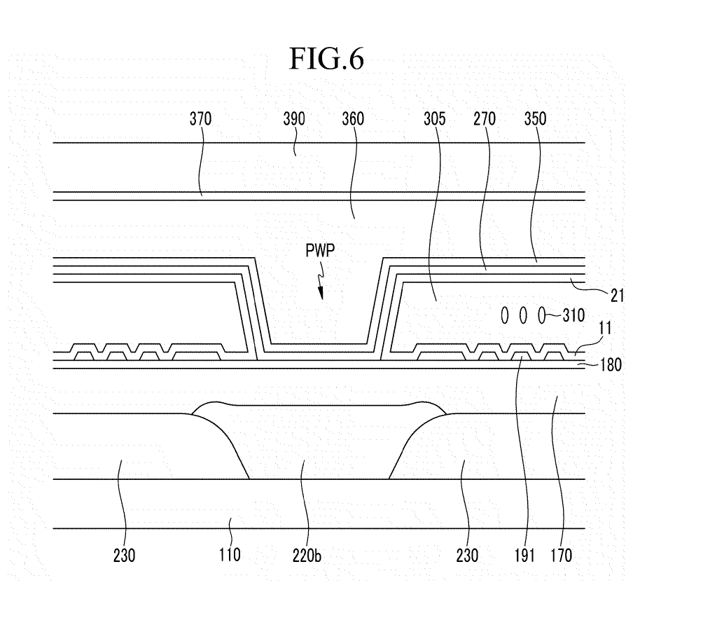

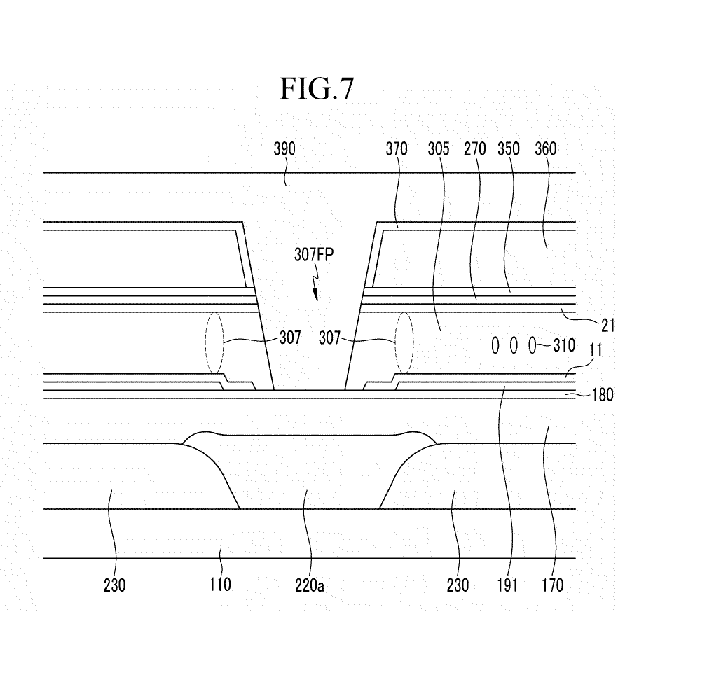

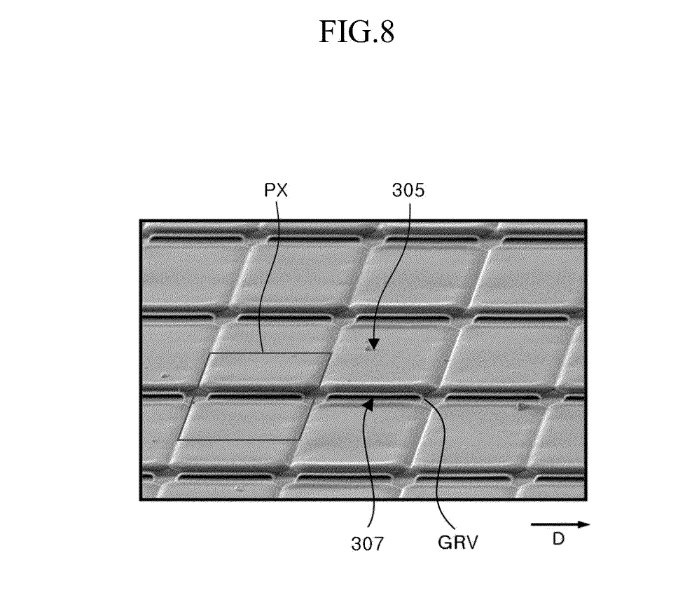

FIG. 5 is a plan view illustrating an embodiment of a liquid crystal display according to an exemplary embodiment. FIG. 6 is a cross-sectional view of the liquid crystal display of FIG. 5 taken along line VI-VI. FIG. 7 is a cross-sectional view of the liquid crystal display of FIG. 5 taken along line VII-VII. FIG. 8 is a perspective view illustrating a microcavity according to an exemplary embodiment.

Referring to FIGS. 5 to 7, thin film transistors Qa, Qb, and Qc are disposed on the substrate 110, which may comprise transparent glass or plastic.

Color filters 230 are disposed on the thin film transistors Qa, Qb, and Qc, and a light blocking member 220 may be formed between the adjacent color filters 230.

FIGS. 6 and 7 are cross-sectional views taken along lines VI-VI and VII-VII, and a constituent element between the substrate 110 (shown in FIGS. 1 and 4) and the color filter 230 illustrated in FIG. 5 is omitted in FIGS. 6 and 7. Also, in FIGS. 6 and 7, a part of the constituent elements of the thin film transistors Qa, Qb, and Qc is included between the substrate 110 and the color filter 230.

The color filter 230 may be elongated in a column direction of the pixel electrode 191. The color filter 230 may display a primary colors such as the three primary colors of red, green, and blue. However, the color filter 230 is not limited to the three primary colors of red, green, and blue, but may display one of cyan, magenta, yellow, and, white colors.

The adjacent color filters 230 may be spaced apart from each other in a horizontal direction D and a vertical direction crossing the horizontal direction illustrated in FIG. 5. FIG. 6 illustrates the color filters 230 spaced apart from each other in the horizontal direction D, and FIG. 7 illustrates the color filters 230 spaced apart from each other in the vertical direction.

Referring to FIG. 6, a vertical light blocking member 220b is disposed between the color filters 230 spaced apart from each other in the horizontal direction D. The vertical light blocking member 220b is overlapped with respective edges of the adjacent color filters 230, and widths at which the vertical light blocking member 220b is overlapped with both edges of the color filter are substantially the same as each other.

Referring to FIG. 7, a horizontal light blocking member 220a is positioned between the color filters 230 spaced apart from each other in the vertical direction. The horizontal light blocking member 220a is overlapped with respective edges of the adjacent color filters 230, and widths at which the horizontal light blocking member 220a is overlapped with both edges of the color filter are substantially the same as each other.

Unlike those described above, the light blocking member 220 may be positioned on a microcavity 305 to be described below, and in this case, the color filters 230 may be continuously formed in the vertical direction or color filters displaying different colors may be overlapped with each other at the edges.

A first passivation layer 170 is positioned on the color filter 230 and the light blocking member 220. The first passivation layer 170 may include an inorganic material or an organic material, and may serve to planarize layers formed at the lower portion.

The insulating layer 180 is positioned on the first passivation layer 170. The insulating layer 180 includes silicon oxide or silicon nitride, and has an —OH group attached to its surface. The pixel electrode 191 is disposed on the insulating layer 180, and the pixel electrode 191 is electrically connected with one terminal of the thin film transistors Qa and Qb through contact holes 185a and 185b (shown in FIG. 5).

A lower alignment layer 11 is formed on the pixel electrode 191 and may be a vertical alignment layer. An upper alignment layer 21 is disposed at a portion facing the lower alignment layer 11, and the microcavity 305 is formed between the lower alignment layer 11 and the upper alignment layer 21.

In the exemplary embodiment, the lower alignment layer 11 and the upper alignment layer 21 include the self-assembled monolayer (“SAM”) derived from at least the first precursor compound and the second precursor compound, wherein the first and second precursor compounds are different. In detail, the self-assembled monolayer in the exemplary embodiment may be derived by mixing a first precursor compound represented by the following Chemical Formula A and a second precursor compound represented by the following Chemical Formula B.

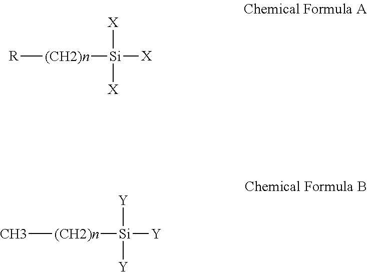

In Chemical Formulas A and B,

R is a functional group including a double bond,

n is 1 to 30, and

X and Y are each independently —Cl, —OCH₃, or —OC₂H₅.

R may be a vinyl group, an acrylate group, or a methacrylate group.

In the exemplary embodiment, the first precursor compound may be at least one of compounds represented by the following chemical formulas 1 to 8.

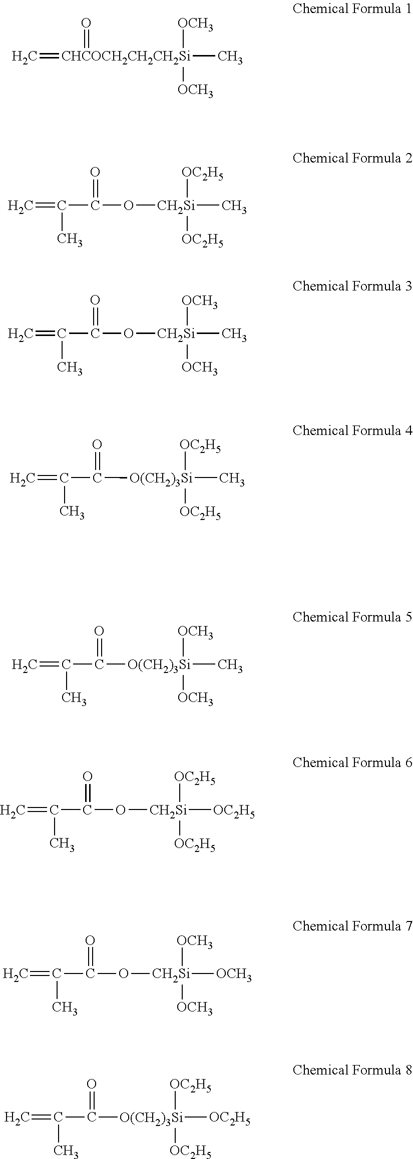

In the exemplary embodiment, the second precursor compound may be at least one of octadecyltrichlorosilane (“OTS”) and octadecyltrimethoxysilane (“OTMS”).

In the exemplary embodiment, the self-assembled monolayer may be derived by mixing a third precursor compound represented by the following Chemical Formula C with the first precursor compound and the second precursor compound.

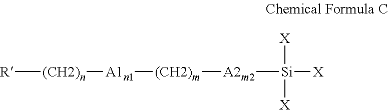

In Chemical Formula C,

R′ is a functional group including a methyl group or a double bond,

n, n1, m, and m2 are each independently 1 to 30,

A1 and A2 are each independently a C3 to C30 cyclohydrocarbylene group, and

each X is independently —Cl, —OCH₃, or —OC₂H₅.

In the exemplary embodiment, the liquid crystal layer 3 may include the liquid crystal 310 (shown in FIGS. 1 and 4) and an alignment polymer. The alignment polymer may be formed by irradiating light onto the liquid crystal 310 and the alignment assistant agent. The alignment polymer reacts with the self-assembled monolayer derived from the first precursor compound described above to generate a pretilt component of the liquid crystal 310. Also, the self-assembled monolayer derived from the second precursor compound may serve to vertically align the liquid crystal 310 due to the alkyl group which is disposed at an end thereof.

The description for the alignment layer described in FIGS. 1 to 3 may also be applied to the alignment layers 11 and 21 according to the exemplary embodiment.

As shown in FIG. 6, a liquid crystal material including liquid crystal molecules 310 is injected into the microcavity 305, and the microcavity 305 has a liquid crystal injection hole 307. The microcavity 305 may be formed in a column direction, that is, a vertical direction of the pixel electrode 191. In the exemplary embodiment, an alignment material forming the alignment layers 11 and 21 and a liquid crystal material including the liquid crystal molecules 310 may be injected into the microcavity 305 by using capillary force.

As also illustrated in FIG. 6, a partition wall formation part PWP is positioned between the microcavities 305 adjacent to each other in a horizontal direction.

In the exemplary embodiment, the respective liquid crystal injection holes are formed one by one at both edges of one microcavity 305, but in another exemplary embodiment, only one liquid crystal injection hole may be formed at one edge of one microcavity 305.

The upper alignment layer 21 is positioned on the microcavity 305, and the common electrode 270 and a lower insulating layer 350 are positioned on the upper alignment layer 21. The common electrode 270 receives a common voltage and generates an electric field together with the pixel electrode 191 to which a data voltage is applied to determine tilt directions of the liquid crystal molecules 310 positioned in the microcavity between the two electrodes. The common electrode 270 forms a capacitor together with the pixel electrode 191 to maintain the applied voltage even after the thin film transistor is turned off. The lower insulating layer 350 may include silicon nitride (SiNx) or silicon oxide (SiO2).

In the exemplary embodiment, the common electrode 270 is formed on the microcavity 305, but in another exemplary embodiment, the common electrode 270 is formed below the microcavity 305. Thus the liquid crystal may be driven according to an in-plane switching mode.

A roof layer 360 is disposed on the lower insulating layer 350. The roof layer 360 may include silicon oxycarbide (“SiOC”), photoresist, or other organic materials. In the case where the roof layer 360 includes the silicon oxycarbide (“SiOC”), the roof layer 360 may be formed by a chemical vapor deposition method, and in the case where the roof layer 360 includes the photoresist, the roof layer 360 may be formed by a coating method. The silicon oxycarbide (“SiOC”) has high transmittance and low film stress among layers which may be formed by a chemical vapor deposition method and thus is not modified. Accordingly, in the exemplary embodiment, when the roof layer 360 is formed of the silicon oxycarbide (“SiOC”), light passes through the roof layer 360 well to form a stable layer.

As shown in FIG. 7, a liquid crystal injection hole formation region 307FR which passes though the microcavity 305, the common electrode 270, the lower insulating layer 350, and the roof layer 360 is formed on the horizontal light blocking member 220a. The liquid crystal injection hole formation region 307FR is covered by a capping layer 390 described below.

The upper insulating layer 370 is disposed on the roof layer 360. The upper insulating layer 370 may contact an upper surface and a side wall of the roof layer 360. The upper insulating layer 370 may be formed of silicon nitride (“SiNx”) or silicon oxide (SiO2). The capping layer 390 is positioned on the upper insulating layer 370. The capping layer 390 contacts the upper surface of the side of the upper insulating layer 370 and covers the liquid crystal injection hole 307 of the microcavity 305 exposed by the liquid crystal injection hole formation region 307FR. The capping layer 390 may include a thermosetting resin, silicon oxycarbide (“SiOC”), or Graphene.

In an embodiment wherein the capping layer 390 includes graphene, graphene may serve as a capping layer blocking the liquid crystal injection hole 307, since the graphene has high impermeability for gas including helium and the like, the graphene may serve as a capping layer which blocks the liquid crystal injection hole 307. In addition, since the graphene is a material including carbon bonds, the liquid crystal material does not become contaminated even though the graphene contacts the liquid crystal material. In addition, the graphene may serve to protect the liquid crystal material from external oxygen and moisture.

An overcoat (not illustrated) including an inorganic layer or an organic layer may be disposed on the capping layer 390. The overcoat serves to protect the liquid crystal molecules 310 injected into the microcavity 305 from external impact and to planarize the layer.

Hereinafter, the microcavity 305 will be described in further detail with reference to FIGS. 5 to 8.

Referring to FIGS. 5 to 8, a plurality of microcavities 305 is divided in a vertical direction by a plurality of liquid crystal injection hole formation regions 307FR which are disposed at a portion overlapped with a gate line 121a, and formed in an extending direction D of the gate line 121a. Each of the plurality of microcavities 305 may correspond to a pixel area, and a plurality of microcavity 305 groups may be disposed in a column direction. Here, the pixel area may correspond to an area displaying a screen.

In the exemplary embodiment, two subpixel electrodes 191a and 191b have a thin film transistor and a pixel electrode structure which are disposed with the gate line 121a therebetween. Accordingly, in the microcavity 305, the first subpixel electrode 191a and the second subpixel electrode 191b included in respective pixels PX adjacent to each other in a vertical direction may correspond to one microcavity 305. However, since the thin film transistor and the pixel electrode structure may be modified, the structure may be modified to have a form in which the microcavity 305 corresponds to one pixel PX.

In this case, the liquid crystal injection hole formation region 307FP formed between the microcavities 305 may be positioned in the extending direction D of the gate line 121a, and the liquid crystal injection hole 307 of the microcavity 305 forms a region corresponding to a boundary of the liquid crystal injection hole formation region 307FP and the microcavity 305. The liquid crystal injection hole 307 is formed in an extending direction of the liquid crystal injection hole formation region 307FP. In addition, the partition wall formation part PWP formed between the microcavities 305 adjacent to each other in the extending direction D of the gate line 121a may be covered by the roof layer 360 as illustrated in FIG. 6. In the exemplary embodiment, the lower insulating layer 350, the common electrode 270, the upper insulating layer 370, and the roof layer 360 are filled in the partition wall formation part PWP, and the structure forms a partition wall to partition or define the microcavity 305.

The liquid crystal injection hole 307 included in the microcavity 305 may have a height between the upper alignment layer 21 and the horizontal light blocking member 220a, or have a height between the upper alignment layer 21 and the lower alignment layer 11.

In the exemplary embodiment, the liquid crystal injection hole formation region 307FP is formed in the extending direction D of the gate line 121a, but in another exemplary embodiment, a plurality of liquid crystal injection hole formation regions 307FP may be formed in a direction in which a data line 171 extends, and a plurality of groups of the plurality of microcavities 305 may be formed in a row direction. The liquid crystal injection hole 307 may be formed in a direction in which the liquid crystal injection hole formation region 307FP extends which is formed in the direction in which the data line 171 extends.

In the exemplary embodiment, since the liquid crystal material is disposed through the liquid crystal injection hole 307 of the microcavity 305, the liquid crystal display may be formed without forming a separate upper substrate.

Hereinafter, referring back to FIGS. 5 to 7, the liquid crystal display according to the exemplary embodiment will be described in further detail.

Referring to FIGS. 5 to 7, a plurality of gate conductors including a plurality of gate lines 121a, a plurality of step-down gate lines 121b, and a plurality of storage electrode lines 131 is formed on the substrate 110 made of transparent glass or plastic.

The gate line 121a and the step-down gate line 121b mainly extend in a horizontal direction to transfer gate signals. The gate line 121a may include a first gate electrode 124a and a second gate electrode 124b protruding upward and downward, and the step-down gate line 121b may include a third gate electrode 124c protruding upward. The first gate electrode 124a and the second gate electrode 124b are connected with each other to form one protrusion.

The storage electrode line 131 extends primarily in a horizontal direction to transfer a predetermined voltage such as a common voltage Vcom. The storage electrode line 131 includes storage electrodes 129 protruding upwards and downwards, a pair of vertical portions 134 extending downwards to be substantially vertical to the gate line 121a, and a horizontal portion 127 connecting ends of the pair of vertical portions 134. The horizontal portion 127 includes a capacitor electrode 137 expanded downwards.

A gate insulating layer (not illustrated) is disposed on the gate conductor 121a, 121b, 131.

A plurality of semiconductor stripes (not illustrated) including amorphous or crystalline silicon is disposed on the gate insulating layer. The semiconductor stripes extend primarily in a vertical direction, and include first and second semiconductors 154a and 154b extending toward the first and second gate electrodes 124a and 124b and connected with each other, and a third semiconductor 154c positioned on the third gate electrode 124c.

A plurality of pairs of ohmic contacts (not illustrated) may be disposed on the semiconductors 154a, 154b, and 154c. The ohmic contact may comprise a silicide or a material such as n+ hydrogenated amorphous silicon in which n-type impurity is doped at high concentration.

Data conductors including a plurality of data lines 171, a plurality of first drain electrodes 175a, a plurality of second drain electrodes 175b, and a plurality of third drain electrodes 175c are formed on the ohmic contacts.

The data lines 171 transfer data signals and mainly extend in a vertical direction to cross the gate lines 121a and the step-down gate lines 121b. Each data line 171 includes a first source electrode 173a and a second source electrode 173b which extend toward the first gate electrode 124a and the second gate electrode 124b and are connected to each other.

A first drain electrode 175a, a second drain electrode 175b, and a third drain electrode 175c include one wide end portion and the other rod-shaped end portion, respectively. The rod-shaped end portions of the first drain electrode 175a and the second drain electrode 175b are partially surrounded by the first source electrode 173a and the second source electrode 173b. One wide end portion of the first drain electrode 175a is again extended to form a third drain electrode 175c which is bent in a U-lettered shape. A wide end portion 177c of the third source electrode 173c is overlapped with the capacitor electrode 137 to form a step-down capacitor Cstd, and the rod-shaped end portion is partially surrounded by the third drain electrode 175c.

The first gate electrode 124a, the first source electrode 173a and the first drain electrode 175a form a first thin film transistor Qa together with the first semiconductor 154a, the second gate electrode 124b, the second source electrode 173b and the second drain electrode 175b form a second thin film transistor Qb together with the second semiconductor 154b, and the third gate electrode 124c, the third source electrode 173c and the third drain electrode 175c form the third thin film transistor Qc together with the third semiconductor 154c.

The semiconductor stripe including the first semiconductor 154a, the second semiconductor 154b and the third semiconductor 154c may have substantially the same plane shape as the data conductors 171, 173a, 173b, 173c, 175a, 175b, and 175c and the ohmic contacts therebelow, except for channel regions between the source electrodes 173a, 173b, and 173c and the drain electrodes 175a, 173b, and 175c.

In the first semiconductor 154a, an exposed portion which is not covered by the first source electrode 173a and the first drain electrode 175a is disposed between the first source electrode 173a and the first drain electrode 175a. In the second semiconductor 154b, an exposed portion which is not covered by the second source electrode 173b and the second drain electrode 175b is disposed between the second source electrode 173b and the second drain electrode 175b. In addition, in the third semiconductor 154c, an exposed portion which is not covered by the third source electrode 173c and the third drain electrode 175c is disposed between the third source electrode 173c and the third drain electrode 175c.

An insulating layer (not illustrated) including an inorganic insulator such as silicon nitride or silicon oxide is disposed on the data conductor 171, 173a, 173b, 173c, 175a, 175b, 175c and the exposed portions of the semiconductors 154a, 154b, and 154c.

The color filters 230 may be disposed on the insulating layer. The color filters 230 are disposed in most of regions except for a place where the first thin film transistor Qa, the second thin film transistor Qb, and the third thin film transistor Qc are positioned. However, the color filters 230 may be elongated in a vertical direction along a space between the adjacent data lines 171. In the exemplary embodiment, the color filters 230 are formed at the lower end of the pixel electrode 191 and may be formed on the common electrode 270.

A light blocking member 220 is positioned on a region where the color filter 230 is not positioned and a part of the color filter 230. The light blocking member 220 extends along the gate line 121a and the step-down gate line 121b to be expanded upward and downward, and includes a horizontal light blocking member 220a which covers a region in which the first thin film transistor Qa, the second thin film transistor Qb, and the third thin film transistor Qc are positioned, and a vertical light blocking member 220b which extends along the data line 171.

The light blocking member 220 is called a black matrix and blocks light leakage.

A plurality of contact holes 185a and 185b exposing the first drain electrode 175a and the second drain electrode 175b are disposed in the insulating layer and the light blocking member 220.

In addition, the first passivation layer 170 and the insulating layer 180 (shown in FIGS. 1 and 4) are disposed on the color filter 230 and the light blocking member 220. The pixel electrode 191 including the first subpixel electrode 191a and the second subpixel electrode 191b are disposed on the insulating layer 180. The first subpixel electrode 191a and the second subpixel electrode 191b are separated from each other with the gate line 121a and the step-down gate line 121b therebetween and disposed upward and downward to be adjacent to each other in a column direction. A size of the second subpixel electrode 191b is larger than a size of the first subpixel electrode 191a and may be approximately one to three times larger than the size of the first subpixel electrode 191a.

An overall shape of the first subpixel electrode 191a and the second subpixel electrode 191b is a quadrangle, and the first subpixel electrode 191a and the second subpixel electrode 191b include cross stems including horizontal stems 193a and 193b and vertical stems 192a and 192b crossing the horizontal stems 193a and 193b, respectively. Further, the first subpixel electrode 191a and the second subpixel electrode 191b include a plurality of minute branches 194a and 194b, and protrusions 197a and 197b protruding upward or downward from edge sides of the subpixel electrodes 191a and 191b, respectively.

The pixel electrode 191 is divided into four subregions by the horizontal stems 193a and 193b and the vertical stems 192a and 192b. The minute branches 194a and 194b obliquely extend from the horizontal stems 193a and 193b and the vertical stems 192a and 192b, and the extending direction may form an angle of approximately 45 degrees or 135 degrees with the gate lines 121a and 121b or the horizontal stems 193a and 193b. Further, directions in which the minute branches 194a and 194b of the two adjacent subregions extend may be perpendicular to each other.

In the exemplary embodiment, the first subpixel electrode 191a further includes an outer stem surrounding the outside, and the second subpixel electrode 191b includes horizontal portions positioned at an upper end and a lower end and left and right vertical portions 198 positioned at the left and the right of the first subpixel electrode 191a. The left and right vertical portions 198 may prevent a capacitive bond, that is, coupling between the data line 171 and the first subpixel electrode 191a.

The lower alignment layer 11, the microcavity 305, the upper alignment layer 21, the common electrode 270, the lower insulating layer 350, and the capping layer 390 are formed on the pixel electrode 191, and the description of the constituent elements is as described above and will be omitted herein.

The description of the liquid crystal display described above is one example of a structure having improving side visibility, and the structure of the thin film transistor and the design of the pixel electrode are not limited to the structure described in the exemplary embodiment, but modified to apply the content according to the exemplary embodiment.

Further, the liquid crystal display including the alignment layer according to the exemplary embodiment is applied to the nano crystal display (“NCD”), but is not limited to the NCD liquid crystal display, and the exemplary embodiment may be applied to various forms of technologies of the liquid crystal display in which an upper panel including the upper substrate corresponding to the lower substrate 110 is separately formed, and the upper panel and the lower panel are attached to each other. However, in the case of the NCD, since the alignment layer is formed by disposing an alignment material through the liquid crystal injection hole, it would be desirable to prevent a solid aggregation phenomenon as occurs in the related art is greater. Accordingly, it is significant that the exemplary embodiment is applied to the NCD.

Hereinafter, a method of forming the microcavity 305 according to the exemplary embodiment will be further described.

Referring back to FIGS. 6 and 7, a sacrificial layer is formed of a material including a photoresist on the pixel electrode 191, and the partition wall formation part PWP is formed on the vertical light blocking member 220b by exposing/developing or patterning the sacrificial layer. The partition wall formation part PWP may partition the microcavities 305 adjacent to each other in a horizontal direction.

Referring to FIG. 6, the common electrode 270 and the lower insulating layer 350 are sequentially formed on the sacrificial layer. The common electrode 270 may be formed of a transparent conductor such as ITO or IZO, and the lower insulating layer 350 may be formed of silicon nitride (SiNx) or silicon oxide (SiO₂). The roof layer 360 and the upper insulating layer 370 are sequentially formed on the lower insulating layer 350. The roof layer 360 according to the exemplary embodiment may be formed of a different material from the sacrificial layer 300 described above. The upper insulating layer 370 may be formed of silicon nitride (SiNx) or silicon oxide (SiO₂).

Referring to FIG. 7, the liquid crystal injection hole formation region 307FP exposing the lower insulating layer 350 of a portion corresponding to the horizontal light blocking member 220a may be formed by patterning the roof layer 360 before forming the upper insulating layer 370. Thereafter, the sacrificial layer 300 is exposed by sequentially patterning the upper insulating layer 370, the lower insulating layer 350, and the common electrode 270 positioned at the portion corresponding to the liquid crystal injection hole formation region 307FP, and the sacrificial layer 300 is removed through the liquid crystal injection hole formation region 307FP by oxygen (02) ashing treatment or a wet etching method. In this case, the microcavity 305 having the liquid crystal injection hole 307 is formed. The microcavity 305 is an empty space in which the sacrificial layer is removed.

The alignment layers 11 and 21 are formed on the pixel electrode 191 and the common electrode 270 by injecting the alignment material through the liquid crystal injection hole 307.

Next, the liquid crystal including the liquid crystal 310 is injected into the microcavity 305 through the liquid crystal injection hole 307 by using, for example, an inkjet method.

According to the exemplary embodiment, the alignment assistant agent is injected together with the liquid crystal 310, and the liquid crystal 310 and the alignment assistant agent are light-irradiated in a state when the voltages are applied to the pixel electrode 191 and the common electrode 270, that is, the electric field is generated. In this case, an alignment polymer may be formed.

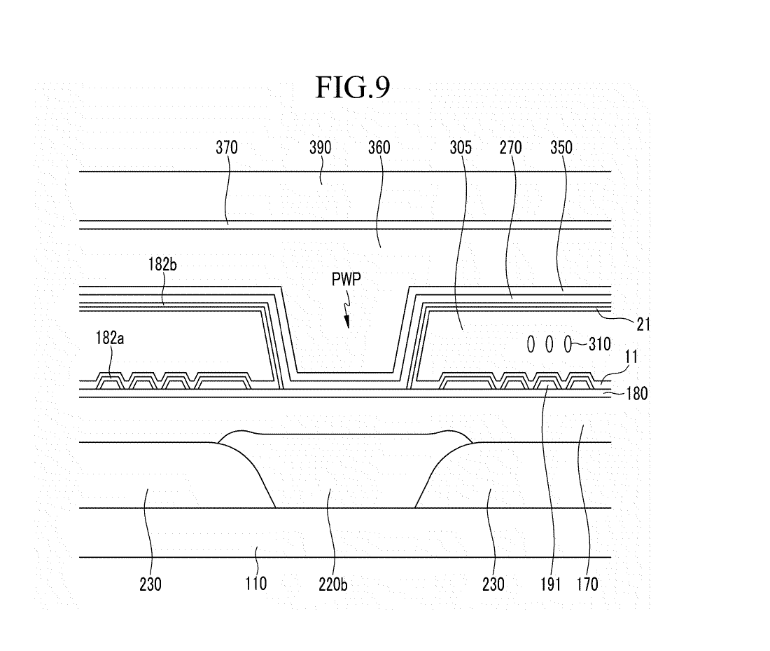

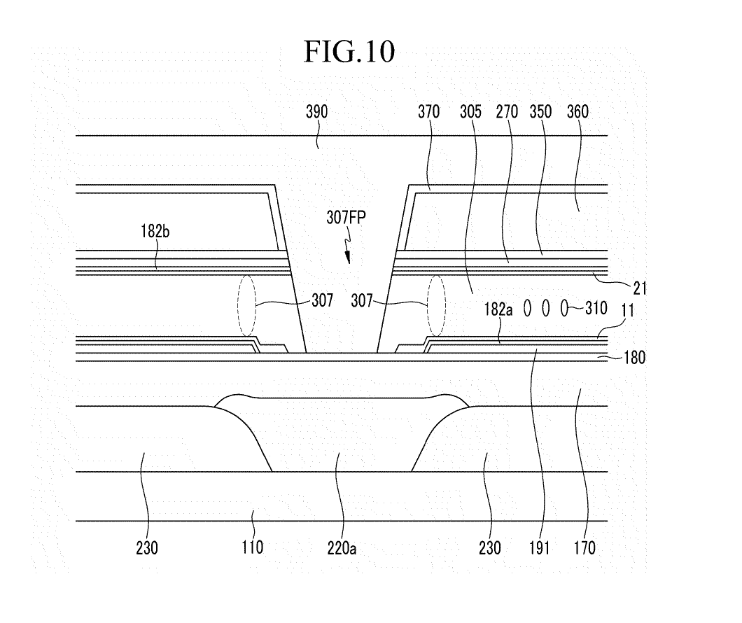

FIGS. 9 and 10 are cross-sectional views of the liquid crystal display of FIG. 5 taken along lines VI-VI and VII-VII in order to illustrate the liquid crystal display modifying the exemplary embodiments described in FIGS. 6 and 7, respectively.

Referring to FIGS. 9 and 10, the exemplary embodiment has almost the same constituent elements as the exemplary embodiment described in FIGS. 6 and 7, and the same description is applied, but a first overcoat 182a covering the pixel electrode 191 and a second overcoat 182b covering the common electrode 270 are formed on the insulating layer 180. Instead, the treatment of the upper surface of the pixel electrode 191 or the common electrode 270 with ultraviolet rays, ozone (O₃), or the SC1 method described in FIGS. 6 and 7 may be omitted. Since the overcoats 182a and 182b may be formed of silicon nitride (SiNx) or silicon oxide (SiO₂), and —OH groups are naturally formed on the surfaces of the overcoats 182a and 182b, an effect of the ultraviolet ray treatment, ozone (O₃) treatment, or SC1 method treatment may be achieved.

However, in the exemplary embodiment, the overcoats 182a and 182b are formed to cover the pixel electrode 191 and the common electrode 270, respectively, but an overcoat may be formed to cover only one of the pixel electrode 191 and the common electrode 270, and a process of the ultraviolet ray treatment, ozone (O₃) treatment, or SC1 method treatment may be added.

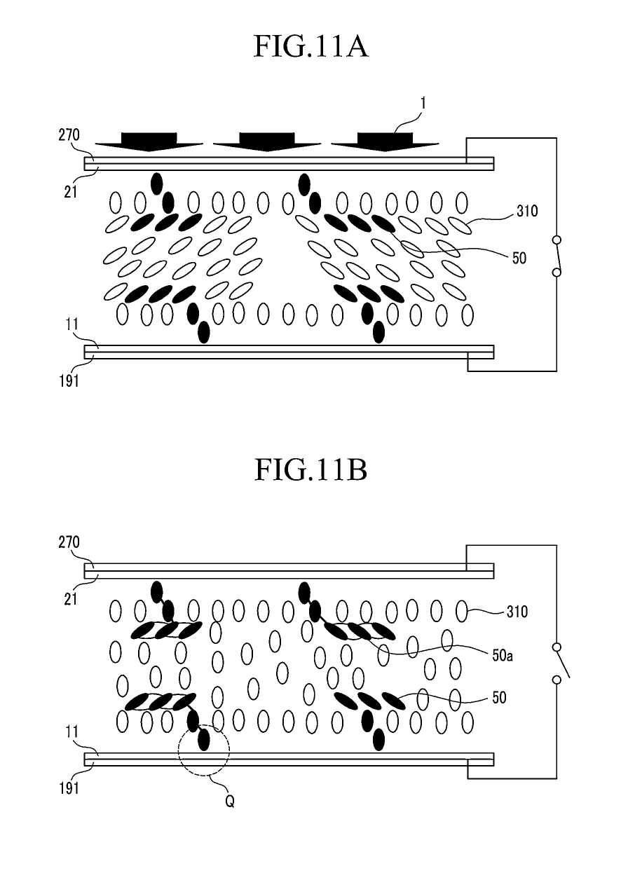

FIGS. 11A and 11B are schematic diagrams illustrating a method of forming a pretilt of a liquid crystal by an alignment assistant agent according to an exemplary embodiment.

This will be described with reference to FIGS. 11A and 11B in addition to FIG. 1.

Referring to FIGS. 1 and 11A, the alignment layers 11 and 21 are coated on the pixel electrode 191 and the common electrode 270. Thereafter, the liquid crystal layer 3 is formed by assembling the lower panel 100 including the pixel electrode 191 and the upper panel 200 including the common electrode 270 and injecting a mixture of the liquid crystal 310 and an alignment assistant agent 50 therebetween. However, the liquid crystal layer 3 may be formed on the lower panel 100 or the upper panel 200 by a method of dripping the mixture of the liquid crystal 310 and the alignment assistant agent 50.

Thereafter, light 1 is irradiated in the state where the voltages are applied to the pixel electrode 191 and the common electrode 270. Here, the light corresponds to light in an ultraviolet area in which a wavelength band is substantially less than 380 nanometers (“nm”).

Referring to FIG. 11B, the light 1 in the ultraviolet area polymerizes the alignment assistant agent 50 to form an alignment polymer 50a. The alignment polymer 50a may control a pretilt of the liquid crystal 310.

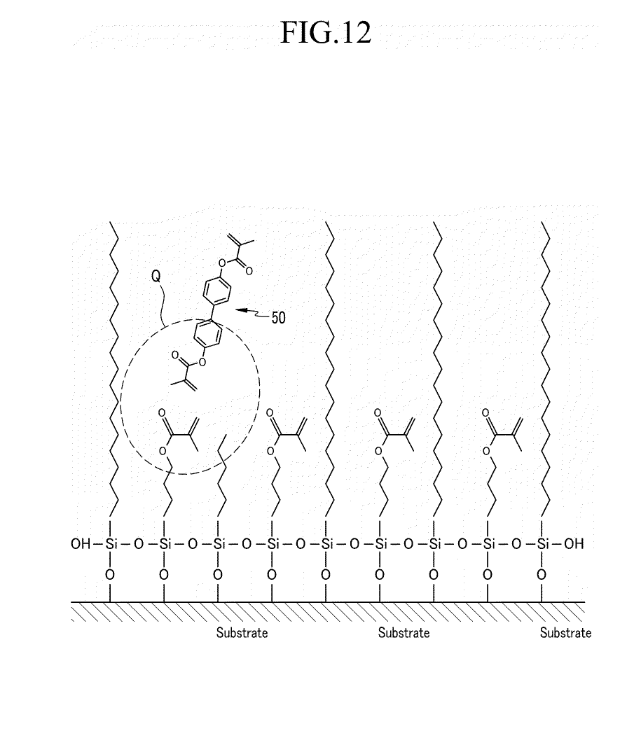

FIG. 12 is a diagram illustrating a position relationship of an alignment layer and an alignment assistant agent in a region Q of FIG. 11B.

Referring to FIGS. 11B and 12, in the exemplary embodiment, the alignment layers 11 and 21 have functional groups including double bonds at the ends and chemically react with the alignment assistant agent 50 to form the alignment polymer 50a.

According to the exemplary embodiment, the alignment layer includes the self-assembled monolayer instead of a PI alignment layer component as known in the related art, but it is not limited thereto, and by reducing a solid component content included in an alignment layer in the related art and mixing a different self-assembled monolayer component with the component in the exemplary embodiment described above, an alignment layer forming vertical alignment and preventing the solid aggregation may be formed.

While this invention has been described in connection with what is presently considered to be practical exemplary embodiments, it is to be understood that the invention is not limited to the disclosed embodiments, but, on the contrary, includes various modifications and equivalent arrangements included within the spirit and scope of the appended claims.

What is claimed is:

1. A liquid crystal display, comprising:
a substrate;
a thin film transistor disposed on the substrate;
a field generating electrode in electrical communication with the thin film transistor; and
an alignment layer disposed on the field generating electrode,
wherein the alignment layer comprises a self-assembled monolayer derived from at least a first precursor compound and a second precursor compound, and
wherein the first and second precursor compounds are different.

2. The liquid crystal display of claim 1, wherein:
the self-assembled monolayer is derived from a combination of the first precursor compound and the second precursor compound, and wherein the first precursor compound is represented by Chemical Formula A and the second precursor compound is represented by Chemical Formula B: 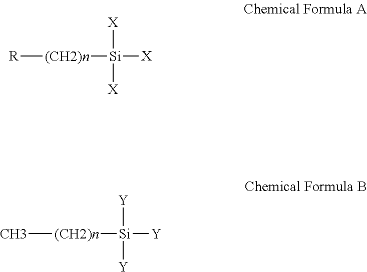
wherein in Chemical Formulas A and B,
R is a functional group comprising a double bond,
n is 1 to 30, and
X and Y are each independently —Cl, —OCH₃, or —OC₂H₅.

3. The liquid crystal display of claim 2, wherein:
the first precursor compound is at least one of compounds represented by Chemical Formulas 1 to 8:

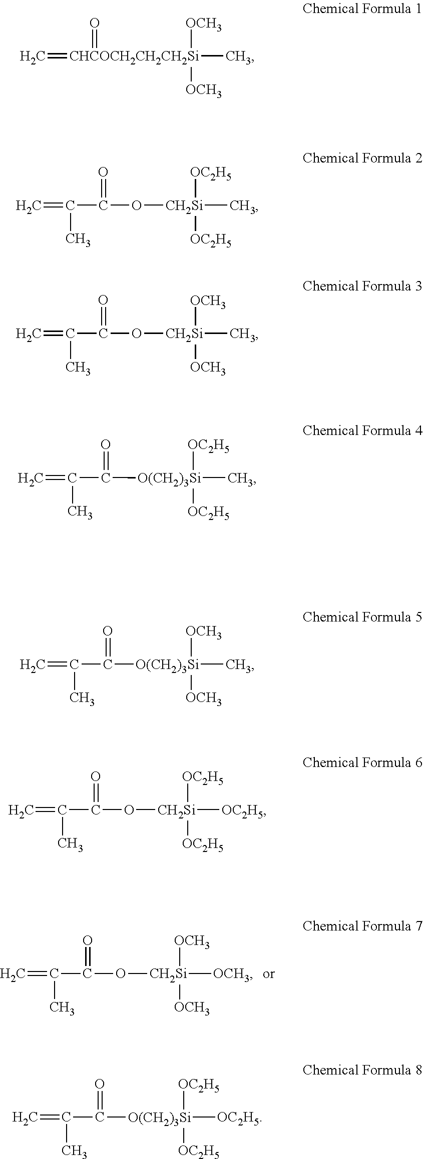

4. The liquid crystal display of claim 3, wherein:
the second precursor compound is at least one of octadecyltrichlorosilane and octadecyltrimethoxysilane.

5. The liquid crystal display of claim 2, further comprising:
a liquid crystal layer disposed on the field generating electrode,
wherein the liquid crystal layer comprises a liquid crystal and an alignment polymer, and
wherein the alignment polymer is a product of light-irradiation of the liquid crystal and an alignment assistant agent.

6. The liquid crystal display of claim 5, wherein:
a portion of the self-assembled monolayer derived from the first precursor compound is a pretilt component, and
a portion of the self-assembled monolayer derived from the second precursor compound is a vertical alignment component.

7. The liquid crystal display of claim 6, wherein:
the alignment assistant agent comprises at least one of compounds represented by Chemical Formulas 9 to 13: 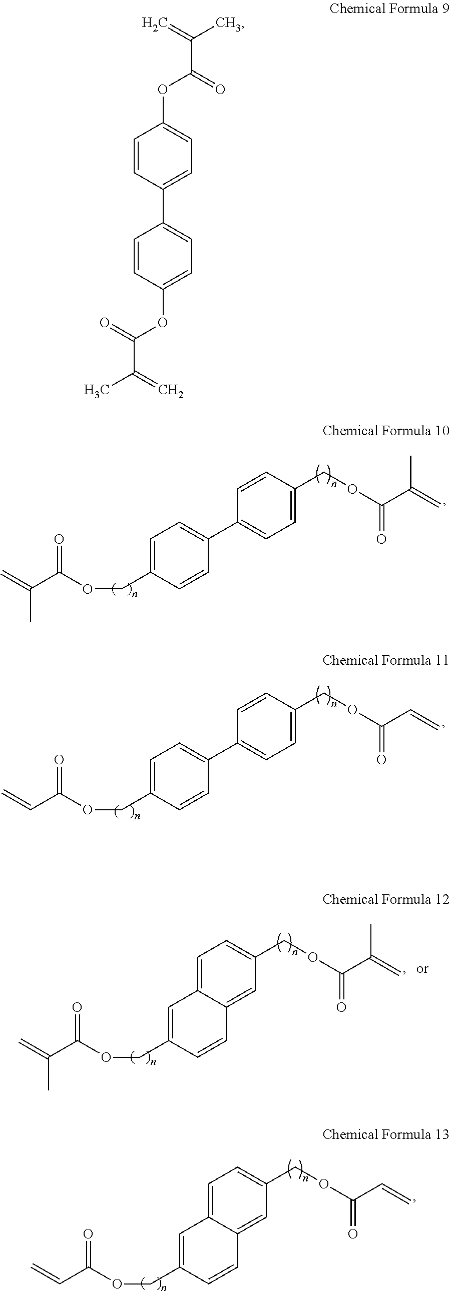
wherein in Chemical Formulas 9-13 n is 0 to 5.

8. The liquid crystal display of claim 7, wherein:
the field generating electrode comprises a plurality of slit electrodes.

9. The liquid crystal display of claim 2, wherein:
the self-assembled monolayer further comprises a product of a third precursor compound represented by Chemical Formula C: 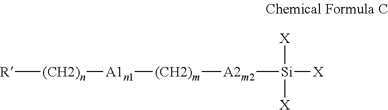
wherein in Chemical Formula C,
R′ is a functional group comprising a methyl group or a double bond,
n, n1, m, and m2 are each independently 1 to 30,
A1 and A2 are each independently a C3 to C30 alicyclic group or a C3 to C30 aryl group, and
each X is independently —Cl, —OCH₃, or —OC₂H₅.

10. The liquid crystal display of claim 1, wherein:
the field generating electrode comprises a surface treated by ultraviolet rays, ozone, or an aqueous combination of ammonium hydroxide and hydrogen peroxide.

11. The liquid crystal display of claim 1, wherein:
the field generating electrode further comprises a first insulating layer comprising silicon nitride or silicon oxide.

12. The liquid crystal display of claim 11, wherein:
the field generating electrode comprises
a plurality of slit electrodes, and
further comprises a second insulating layer comprising silicon nitride or silicon oxide,
wherein the second insulating layer is disposed on the plurality of slit electrodes.

13. The liquid crystal display of claim 1, further comprising:
a liquid crystal layer comprising a liquid crystal disposed on the field generating electrode,
wherein the liquid crystal is vertically aligned when an electric field is not present.

14. The liquid crystal display of claim 1, further comprising:
a roof layer facing the field generating electrode; and
a microcavity comprising a liquid crystal injection hole,
wherein the microcavity is disposed between the field generating electrode and the roof layer, and
wherein the microcavity further comprises a liquid crystal layer comprising the liquid crystal.

15. The liquid crystal display of claim 14, further comprising:
a common electrode disposed between the microcavity and the roof layer.

16. A method of manufacturing a liquid crystal display, the method comprising:
forming a field generating electrode on a first substrate;
forming an alignment layer on the field generating electrode;
forming a liquid crystal layer comprising a liquid crystal and an alignment assistant agent on the field generating electrode;
forming an electric field in the liquid crystal layer; and
light-irradiating the liquid crystal and the alignment assistant agent to form an alignment polymer and manufacture the liquid crystal display,
wherein the alignment layer comprises a self-assembled monolayer derived from a first precursor compound and a second precursor compound, and
wherein the first and second precursor compounds are different.

17. The method of manufacturing a liquid crystal display of claim 16, wherein:
the self-assembled monolayer is derived from a combination of the first precursor compound and the second precursor compound, wherein the first precursor compound is represented by Chemical Formula A and the second precursor compound is represented by Chemical Formula B: 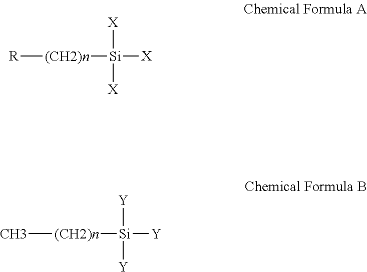
wherein in Chemical Formulas A and B,
R is a functional group comprising a double bond,
n is 1 to 30, and
X and Y are each independently —Cl, —OCH₃, or —OC₂H₅.

18. The method of manufacturing a liquid crystal display of claim 17, wherein:
the first precursor compound is at least one of compounds represented by Chemical Formulas 1 to 8:

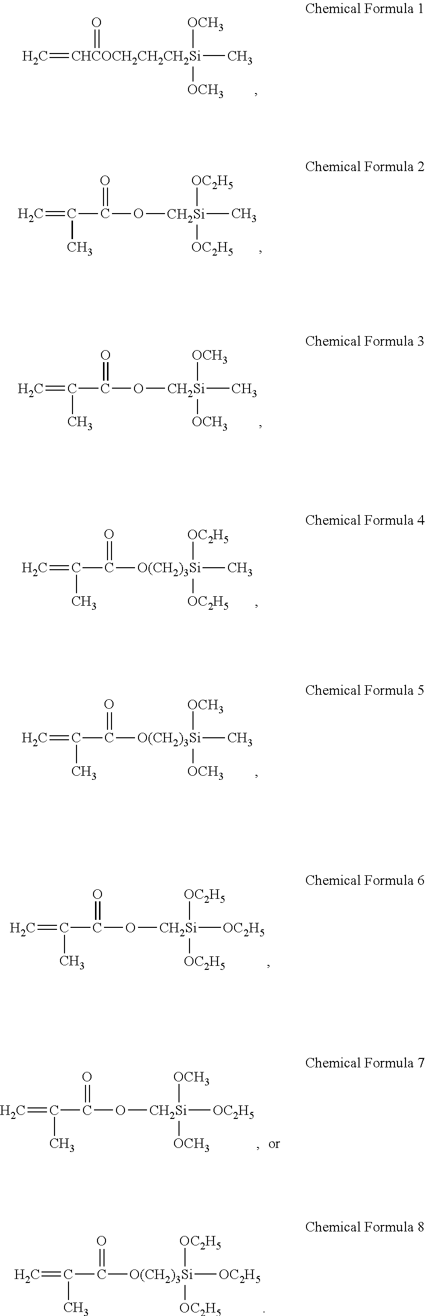

19. The method of manufacturing a liquid crystal display of claim 18, wherein:
the second precursor compound is at least one of octadecyltrichlorosilane and octadecyltrimethoxysilane.

20. The method of manufacturing a liquid crystal display of claim 19, wherein:
a portion of the self-assembled monolayer derived from the first precursor compound is a pretilt component of the liquid crystal, and
a portion of the self-assembled monolayer derived from the second precursor compound is a vertical alignment component of the liquid crystal.

21. The method of manufacturing a liquid crystal display of claim 20, further comprising:
contacting the alignment layer with a solvent before forming an electric field in the liquid crystal layer.

22. The method of manufacturing a liquid crystal display of claim 17, wherein:
the self-assembled monolayer further comprises a product of a third precursor compound represented by Chemical Formula C: 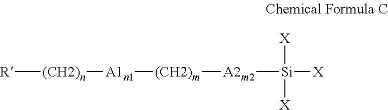
wherein in Chemical Formula C,
R′ is a functional group comprising a methyl group or a double bond,
n, n1, m, and m2 are each independently 1 to 30,
A1 and A2 are each independently a C3 to C30 cyclohydrocarbylene group, and
each X is independently —Cl, —OCH₃, or —OC₂H₅.

23. The method of manufacturing a liquid crystal display of claim 16, further comprising:
treating the field generating electrode with ultraviolet rays, ozone, or an aqueous combination of ammonium hydroxide and hydrogen peroxide.

24. The method of manufacturing a liquid crystal display of claim 16, further comprising:
forming a first insulating layer comprising silicon nitride or silicon oxide on the substrate before forming the field generating electrode.

25. The method of manufacturing a liquid crystal display of claim 24, further comprising:
forming the field generating electrode comprising a plurality of slit electrodes, and
forming a second insulating layer comprising silicon nitride or silicon oxide,
wherein the second insulating layer is disposed on the plurality of slit electrodes.

26. The method of manufacturing a liquid crystal display of claim 16, wherein:
the liquid crystal is disposed vertically when an electric field is not present.

27. The method of manufacturing a liquid crystal display of claim 16, further comprising:
forming a sacrificial layer on the field generating electrode;
forming a roof layer on the sacrificial layer;
removing the sacrificial layer to form a microcavity comprising a liquid crystal injection hole; and
injecting an alignment material and the liquid crystal into the microcavity to form an alignment layer and a liquid crystal layer.

28. The method of manufacturing a liquid crystal display of claim 27, further comprising:
forming a common electrode between the microcavity and the roof layer.

29. The liquid crystal display of claim 1, wherein the self-assembled monolayer is a condensation product of contacting a substrate with the first precursor compound and the second precursor compound.

30. The liquid crystal display of claim 1, wherein the self-assembled monolayer is a hydrolysis product of at least one of the first precursor compound and the second precursor compound.
